(19) United States
(12) Patent Application Publication
(10) Pub. No.: US 2013/0201969 A1
(43) Pub. Date: Aug. 8, 2013

(54) TDM Scheduling Method and Device for Scheduling Uplink Transmissions

(71) Applicants: Jinhua Liu, Beijing (CN); Qingyu Miao, Beijing (CN)

(72) Inventors: Jinhua Liu, Beijing (CN); Qingyu Miao, Beijing (CN)

(73) Assignee: TELEFONAKTIEBOLAGET LM ERICSSON (PUBL), Stockholm (SE)

(21) Appl. No.: 13/643,854

(22) PCT Filed: May 10, 2010
(86) PCT No.: PCT/CN2010/000653

§ 371 Date: Oct. 26, 2012

(51) Int. Cl. H04J 3/16

(52) U.S. Cl. CPC H04J 3/1694
USPC 370/336

(57) ABSTRACT

The invention discloses a TDM scheduling method for scheduling Start uplink transmission in a cellular radio communication system, comprising: obtaining relevant parameters including an Uplink pilot quality for each TDM User Equipment in a cell and an available TDM load for TDM UEs in the cell; determining a TDM group size as a number of TDM UEs to be scheduled to transmit simultaneously in a Transmission Time Interval, TTI, by using the obtained relevant parameters; and scheduling the TDM UEs according to the determined TDM group size. The TDM UEs refer to the UEs to be scheduled according to the TDM scheduling method of the present invention in the cell. With the solution of the invention, the UL system performance can be improved. The proposed solution is easy to be implemented.

### TECHNICAL FIELD

The present invention relates to cellular radio communications, in particular to a Time Division Multiplexing (TDM) scheduling method and device for scheduling Uplink transmissions in a cellular radio communication system.

### BACKGROUND

In the cellular radio communication system, such as an Enhanced Uplink (EUL) system, User Equipments (UE) share the interference in uplink. In order to keep the stability as well as the uplink coverage of the system, there is an upper limit of uplink interference for each cell, which is usually in term of Rise over Thermal (RoT) target or Received Total Wideband Power (RTWP) target. The general EUL description is given in 3GPP specification, “3GPP TS 25.309 v6.6.0, FDD enhanced uplink; Overall description; Stage 2”.

The uplink scheduler allocates the uplink interference among the UEs within the given interference limit by sending grants to UEs. With the current 3GPP specification, there are 2-ms and 10-ms Transmission Time Interval (TTI) lengths. For 10-ms TTI length, there are 4 Hybrid Automatic Repeat Request (HARQ) processes in a HARQ round trip, where the absolute grant is applied to all HARQ processes when it is received. For the 2-ms length, there are 8 HARQ processes in a HARQ round trip, where one absolute grant can be used to set the grant for all HARQ processes or one specific HARQ process. For both 2-ms and 10-ms TTI length, a serving or non-serving relative grant is used to adjust the grant for a HARQ process individually. FIG. 1 illustrates how a relative grant adjusts the serving grant of a HARQ process. A serving or non-serving relative grant is interpreted relative to the UE power ratio in the previous TTI for the same hybrid ARQ process as the transmission which the relative grant will affect. Using the grant mechanism specified in the above 3GPP specification, the HARQ process specific grant setting is doable, which means that a UE can be scheduled to transmit by configuring non-zero grants in some HARQ processes and not to transmit by configuring zero grant in the rest HARQ processes.

According to whether the HARQ process specific grant allocation is used or not, the uplink scheduling strategy can be divided into two types: Code Division Multiplexing (CDM) and TDM. FIG. 2 illustrates a CDM scheduling example. With CDM scheduling scheme, all UEs are scheduled to transmit in each TTI. FIG. 3 illustrates a 4-UE TDM scheduling example where only one UE are allowed to transmit in each TTI.

As more advanced features, such as multiple receiver antennas, advanced receivers and Continuous Packet Connectivity (CPC), are introduced into the EUL system, the Uplink interface capability is improved. It is possible that the Uplink Uu capability is even larger than the UE capability as the evolving of the EUL system. In order to efficiently utilize the UL capability of Uu interface and serve more UEs, one or multiple rather than always single UE may be scheduled to transmit simultaneously in one TTI with TDM scheduling.

In other words, a group of UEs may be allowed to transmit for each HARQ process instead of that always single UE is allowed to transmit in one TTI with TDM scheduling in order to maximize the system performance. In Patent No. U.S. Pat. No. 7,047,016, Method and Apparatus for Allocating Uplink Resources in a MIMO Communication System, the UEs are grouped based on the channel response by estimating the performance of all sub-hypothesis and channel response and a particular order is selected to process the received signals of these UEs for better Successive Interference Cancellation (SIC) effect.

The existing scheduling proposals in MU-MIMO area rely too much on the channel response measurement which means the high cost to use them in the real product because:

1) The channel response measurement should be introduced in physical layer and the channel correlation between different UEs should be estimated, which not only means a high implementation complexity but also a high computation complexity;

2) The interaction between Media Access Control (MAC) scheduler and physical layer is increased which results in the flexibility loss of MAC scheduler.

Another problem is that since the channels of all UEs are changing very fast, the channel measurement accuracy and delay weaken the gain by to such kinds of complex solutions.

### SUMMARY

This invention proposes a TDM scheduling method of low complexity for scheduling of TDM UEs in a cell, wherein the TDM UEs refer to the UEs to be scheduled according to the TDM scheduling method of the present invention in the cell. Instead of scheduling based on using the explicit channel response as shown in the prior arts, this invention uses scheduling parameters, such as, the UL pilot quality (e.g. one or more of DPCCH CINR, DPCCH SINR, DPCCH RSCP or DPCCH SNR) to estimate the number of TDM UEs that may be scheduled to transmit simultaneously in one TTI together with other inputs such as the available TDM load, the UL receiver capability and quality of service (QoS).

In one aspect of the invention, a TDM scheduling method for scheduling uplink transmission in a cellular radio communication system is provided, which includes: obtaining relevant parameters including an Uplink pilot quality for each TDM UE in a cell and an available TDM load, for TDM UEs in the cell; determining a TDM group size as a number of TDM UEs to be scheduled to transmit simultaneously in a TTI by using the obtained relevant parameters; and scheduling the TDM UEs according to the determined TDM group size.

In a further aspect of the invention, a TDM scheduling device for scheduling uplink transmission in a cellular radio communication system is provided, which includes: an obtaining module for obtaining relevant parameters including an Uplink pilot quality for each TDM UE in a cell and an available TDM load for TDM UEs in the cell; a determining module for determining a TDM group size as a number of TDM UEs to be scheduled to transmit simultaneously in a TTI by using the obtained relevant parameters; and a scheduling module for scheduling the TDM UEs according to the determined TDM group size.

The invention also proposes a computer program product containing a computer readable medium having thereon computer program code means adapted, when the program is loaded onto a computing apparatus, to make the computing apparatus execute the TDM scheduling method according to the invention. Meanwhile, the invention proposes a computer program, distributable by electronic data transmission, containing computer program code means adapted, when the program is loaded onto a computing apparatus, to make the computing apparatus execute the TDM scheduling method according to the invention.

With the solution of the invention, the UL system performance can be improved. And the proposed solution is easy to be implemented.

### BRIEF DESCRIPTION OF THE DRAWINGS

In the following section, the invention will be described with reference to exemplary embodiments illustrated in the drawings, in which:

FIG. 1 illustrates Timing relation for Relative Grant (10-ms TTI) in prior art;

FIG. 2 illustrates a CDM scheduling example with 4 UEs (2-ms TTI) in prior art;

FIG. 3 illustrates a 4-UEs TDM scheduling example with singe UE per TTI in prior art;

FIG. 4 illustrates a TDM scheduling method in EUL system of the present invention;

FIG. 5 illustrates an exemplary embodiment for performing the step of determining a TDM group size;

FIG. 6 illustrates a schematic diagram of a cellular radio communication system;

FIG. 7 illustrates a structural block diagram of a TDM scheduling device in the present invention; and

FIG. 8 illustrates a structural block diagram of the determining module in the TDM scheduling device shown in FIG. 7.

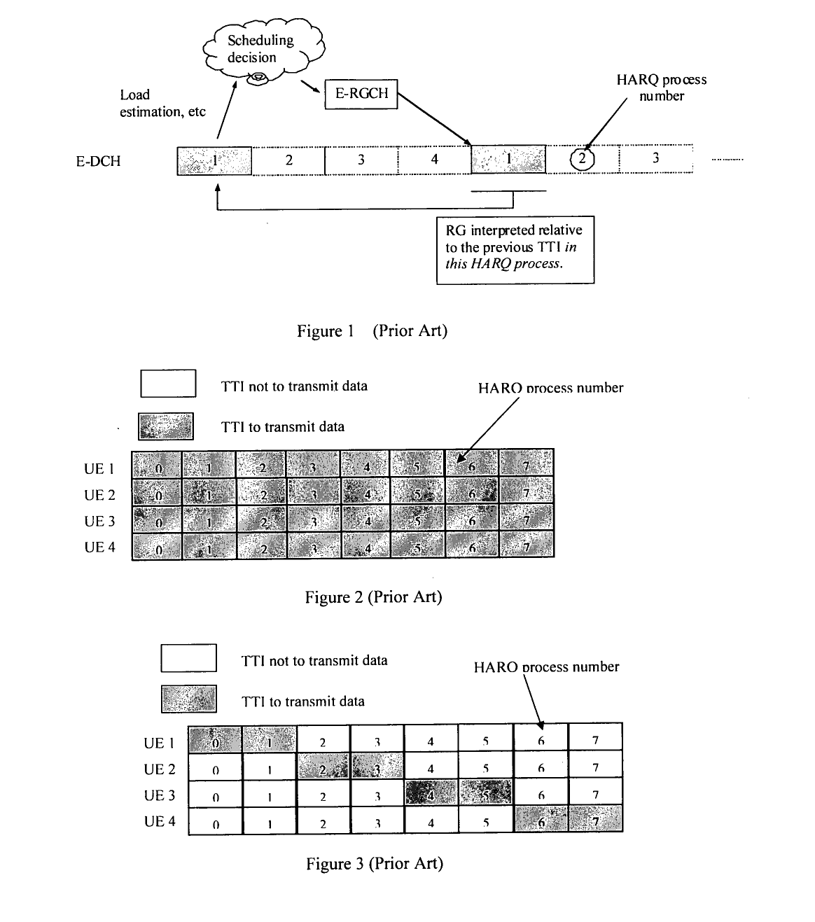

### DETAILED DESCRIPTION

Embodiments of the present invention will be described by referring to the accompanying drawings.

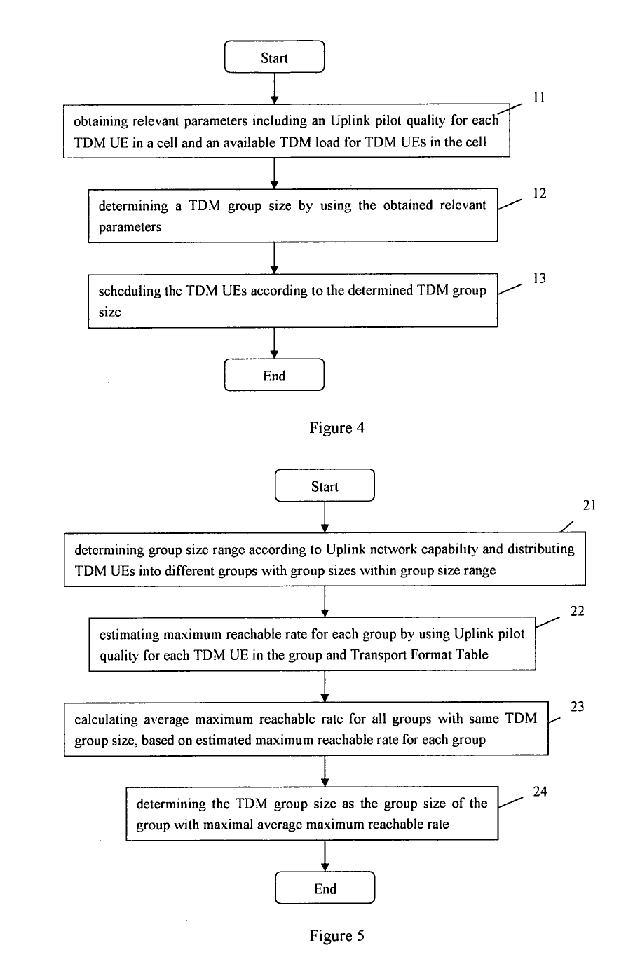

FIG. 4 illustrates a TDM scheduling method in a EUL system of the present invention. As illustrated in step 11, relevant parameters for a certain cell are obtained. The relevant parameters include an Uplink pilot quality for each TDM UE in the cell, such as one or more of DPCCH CINR, DPCCH SINR, DPCCH RSCP or DPCCH SNR, and an available

TDM load for TDM UEs in the cell. In step 12, a TDM group size is determined by using the relevant parameters obtained in step 11. The TDM group size is defined as the number of TDM UEs to be scheduled to transmit simultaneously in a certain TTI. In step 13, the TDM UEs are scheduled according to the TDM group size determined in step 12.

FIG. 5 illustrates an exemplary embodiment for performing the step of determining a TDM group size. In step 21, a group size range is determined according to the uplink Uu capability and the TDM UEs are distributed into different groups with the group sizes within the group size range, wherein a certain UE can be distributed in multiple groups; In step 22, for each group, the available TDM load is tentatively allocated to each TDM UE in the group according to a given load allocation strategy, and then the maximum reachable rate of each group is estimated using Uplink pilot quality for each TDM UE in the group and a given Transport Format Table; in step 23, an average maximum reachable rate for all groups with same TDM group size is calculated based on the estimated maximum reachable rate for each group; and in step 24, the TDM group size is determined as the group size of the group with a maximal average maximum reachable rate.

In particular, an example is illustrated as follows. Assume there are N TDM UEs in a certain cell. The number of TDM UEs that should be scheduled to transmit in , a TTI is referred as TDM group size in the following. The TDM group size can be estimated by the following steps:

Step 1: List a part of or all possible TDM UE groups with the groupSize=1, 2, 3, . . . , M (M≦N) , where M is the maximum TDM group size based on the UL network capability, which should be a constant value for a given network.

Step 2: Estimate the maximum reachable rate for each group.

a. For a certain group, assume the available TDM load for a TDM UE in this group is L_{TDM}/groupSize, where groupSize is the number of TDM UEs in this group.

b. Estimate the maximum reachable rate for each TDM UE in this group and the maximum reachable rate of this group by summing up the maximum reachable rates of all TDM UEs in this group, based on the algorithm described hereinafter.

Step 3: For all groups with the same groupSize, calculate the average maximum reachable rate based on the estimated maximum reachable rate according to Step 2.

Step 4: Determine the TDM group size. The TDM group size is equal to the group size with a maximal average maximum reachable rate calculated from Step 3.

The TDM scheduler should schedule the number of TDM UEs to transmit simultaneously in the TTI according to the group size determined in step 4.

The TDM group size may be updated in various ways. For example, the TDM group size is updated by repeating the above steps as the available TDM load varies. Alternatively, the TDM group size is updated periodically by repeating the above steps.

The following descriptions give an illustration for the algorithm that may be used during the implementation. The available TDM load for TDM UEs in a certain cell can be estimated in the following formula (1):

L_{TDM}=L_{MAX}−L_{dch}−L_{edch,CDM}−L_{hsdpcch}−Lₒₜₕₑᵣ (1)

Where L_{MAX} is the maximum available load in the cell, L_{DCH} is the load taken by DCH channels of all UEs, L_{edch,CDM} is the load taken by the EUL UEs in CDM scheduling mode, L_{hsdpcch} is the load taken by HS-DPCCH and Lₒₜₕₑᵣ is the load taken by the unmonitored interference.

According to the load estimation formula for the i-th UE can be estimated by Formula (2):

$${L}_{i} = \frac{{γ}_{dpcch}^{i} \cdot ( 1 + {Δ}_{edpcch} + {Δ}_{edch}^{i} )}{antGain + ( 1 - α ) \cdot {γ}_{dpcch}^{i} \cdot ( 1 + {Δ}_{edpcch} + {Δ}_{edch}^{i} )} \qquad ( 2 )$$

Where Lᵢ is the allocated load for the i-th UE, γⁱ_{dpcch} is the DPCCH CINR target or measured DPCCH CINR of the i-th UE, Δ_{edpcch} is the power offset of E-DPCCH UEs, Δⁱ_{edch} is the E-DCH power offset of the i-th UE, antGain is the antenna gain and α is the orthogonality factor of this UE.

When a certain TDM load is allocated for the i-th UE, the maximum E-DCH power offset for this UE can be calculated by Formula (3) :

$${Δ}_{edch}^{i} = \frac{{L}_{i} \cdot antGain}{{γ}_{dpcch}^{i} ( 1 - {L}_{i} + α \cdot {L}_{i} )} - 1 - {Δ}_{edpcch} \qquad ( 3 )$$

With the maximum E-DCH power offset by Formula (3), the maximum E-TFC that the UE is allowed to use can be looked up from a given E-TFC table. The relationship between the maximum E-DCH power offset and a Transport block size is defined in the E-TFC table, and then the maximum reachable rate for the i-th TDM UE in the group is calculated from the Transport block size.

Because the UL pilot quality measurement is already implemented (e.g. The DPCCH CINR is measured per slot for inner loop power control) in the existing EUL system, the complex implementation and computation can be saved.

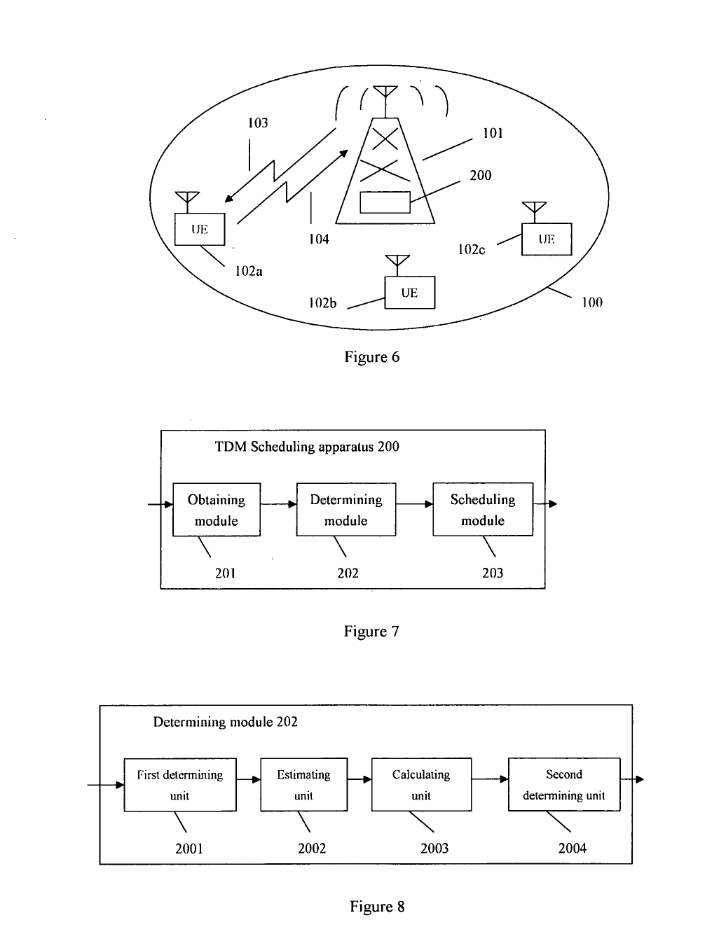

As shown in FIG. 6, a schematic diagram of a cellular radio communication system 100 is provided, including a radio base station 101 serving a cell, which is alternatively referred to as Node B, and UEs (such as 102a, 102b and 102c) operating in the cell. A downlink transmission 103 generally refers to communications in a direction from the radio base station to the UEs. An uplink transmission 104 generally refers to communications in a direction from the UEs to the radio base station. The radio base station 101 contains a TDM scheduling device 200 for scheduling uplink transmissions in a cellular radio communication system.

FIG. 7 illustrates a structural block diagram of a TDM scheduling device 200 according to an embodiment of the present invention. The TDM scheduling device 200 includes: an obtaining module 201 for obtaining relevant parameters including an Uplink pilot quality for each

TDM UE in a cell and an available TDM load for TDM UEs in the cell; a determining module 202 for determining a TDM group size by using the obtained relevant parameters, wherein the TDM group size is defined as a number of TDM UEs to be scheduled to transmit simultaneously in one TTI; and a scheduling module 203 for scheduling the TDM UEs according to the determined TDM group size.

Preferably, as FIG. 8 shows, the determining module 202 may further include: a first determining unit 2001, adapted to determine a group size range according to Uplink network capability and distribute the TDM UEs into different groups with various group sizes; an estimating unit 2002, adapted to estimate a maximum reachable rate for each group by using the Uplink pilot quality for each TDM UE in the group and a E-TFC Table; a calculating unit 2003, adapted to calculate an average maximum reachable rate for all groups with the same TDM group size based on the estimated maximum reachable rate for each group; and a second determining unit 2004, adapted to determine the TDM group size as the group size of the group with a maximal average maximum reachable rate.

Preferably, the estimating unit 2002 may further include: an allocating sub-unit, adapted to, for each group, tentatively allocate an available TDM load of the cell to each TDM UE in the group according to a given load allocation strategy; and an estimating sub-unit, adapted to estimate a maximum reachable rate for each TDM UE in each group, and a maximum reachable rate of each group by summing up the maximum reachable rates of all TDM UEs in the group.

Although the present invention has been particularly shown and described with reference to exemplary embodiments thereof, it will be understood by those skilled in the art that various changes in form and details may be made without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

Abbreviation terms:

DCH: Dedicated Channel

E-DCH: Enhanced Dedicated Channel

DPCCH: Dedicated Physical Control Channel

E-DPCCH: Enhanced Dedicated Physical Control Channel

CINR: Carrier to Interference plus Noise Ratio

RSCP: Received Signal Code Power

SNR: Signal-Noise Ratio

TTI: Transmission Time Interval

TDM: Time Division Multiplexing

DM: Code Division Multiplexing

UL: Uplink

EUL: Enhanced Uplink

SIC: Successive Interference Cancellation

E-TFC: E-DCH Transport Format Combination

CQI: Channel Quality Indicator

SINR: Signal to Interference plus Noise Ratio

MU-MIMO: Multi-User Multi-Input-Multi-Output

UE: User Equipment

HARQ: Hybrid Automatic Repeat Request

RoT: Rise Over Thermal

RTWP: Received Total Wideband Power

CPC: Continuous Packet Connectivity

1-14. (canceled)

15. A Time Division Multiplexing (TDM) scheduling method for scheduling uplink transmission in a cellular radio communication system, comprising:
obtaining parameters that include an Uplink pilot quality for each TDM User Equipment (UE) in a cell and an available TDM load for TDM UEs in the cell;
determining a TDM group size as a number of TDM UEs to be scheduled to transmit simultaneously in a Transmission Time Interval (TTI) by using the obtained parameters; and
scheduling the TDM UEs according to the determined TDM group size.

16. The method of claim 15, wherein the parameters further comprise an Uplink receiver capability and a Quality of Service parameter.

17. The method of claim 15, wherein determining the TDM group size comprises:
determining a group size range according to Uplink network capability and distributing the TDM UEs into different groups with group sizes within the group size range;
estimating a maximum reachable rate for each group by using the Uplink pilot quality for each TDM UE in the group and a Transport Format Table;
calculating an average maximum reachable rate for all groups with the same TDM group size, based on the estimated maximum reachable rate for each group; and
determining the TDM group size as the group size of the group having a maximal average maximum reachable rate.

18. The method of claim 17, wherein estimating the maximum reachable rate for each group comprises:
for each group, tentatively allocating an available TDM load of the cell to each TDM UE in the group according to a given load allocation strategy; and
estimating a maximum reachable rate for each TDM UE in each group and a maximum reachable rate of each group by summing up the maximum reachable rates of all TDM UEs in the group.

19. The method of claim 17, wherein distributing the TDM UEs into different groups comprises distributing a certain TDM UE into multiple groups.

20. The method of claim 15, wherein the TDM group size is updated periodically or as the available TDM load varies.

21. The method of claim 18, wherein an available TDM load of the cell (LTDM) is estimated by a formula as below:
L_{TDM}=L_{MAX}−L_{dch}−L_{edch,CDM}−L_{hsdpcch}−Lₒₜₕₑᵣ
Where L_{MAX} is a maximum available TDM load in the cell, L_{DCH} is a load taken by DCH channels of all UEs, L_{edch,CDM} is a load taken by the Enhanced Uplink UEs in CDM scheduling mode, Lₒₜₕₑᵣ is a load taken by HS-DPCCH and is a load taken by interference not monitored.

22. The method of claim 21, wherein an available TDM load allocated to each TDM UE in the group is L_{TDM}/groupsize.

23. The method of claim 15, wherein the Uplink pilot quality includes one or more of DPCCH CINR, DPCCH SINR, DPCCH RSCP, or DPCCH SNR.

24. A Time Division Multiplexing (TDM) scheduling device for scheduling uplink transmission in a cellular radio communication system, the scheduling device comprising:
an obtaining module adapted to obtain parameters that include an Uplink pilot quality for each TDM User Equipment (UE) in a cell and an available TDM load for TDM UEs in the cell;
a determining module adapted to determine a TDM group size as a number of TDM UEs to be scheduled to transmit simultaneously in a Transmission Time Interval (TTI) by using the obtained parameters; and
a scheduling module, adapted to schedule the TDM UEs according to the determined TDM group size.

25. The device of claim 24, the determining module further comprising:
a first determining unit, adapted to determine a group size range according to Uplink network capability and to distribute the TDM UEs into different groups with group sizes within the group size range;
an estimating unit, adapted to estimate a maximum reachable rate for each group by using the Uplink pilot quality for each TDM UE in the group and a Transport Format Table;
a calculating unit, adapted to calculate an average maximum reachable rate for all groups with the same TDM group size, based on the estimated maximum reachable rate for each group; and
a second determining unit, adapted to determine the TDM group size as the group size of the group with a maximal average maximum reachable rate.

26. The device of claim 25, wherein the estimating unit further comprises:
an allocating sub-unit, adapted to, for each group, tentatively allocate an available TDM load of the cell to each TDM UE in the group according to a given load allocation strategy; and
an estimating sub-unit, adapted to estimate a maximum reachable rate for each TDM UE in each group, and a maximum reachable rate of each group by summing up the maximum reachable rates of all TDM UEs in the group.

27. A computer program product, comprising a non-transitory computer readable medium having thereon computer program code means adapted to, when the program is loaded onto a computing apparatus, make the computing apparatus execute the method of claim 15.
